(19) United States
(12) Patent Application Publication
(10) Pub. No.: US 2026/0163892 A1
(43) Pub. Date: Jun. 11, 2026

(54) SERVICE ANOMALY DETECTION USING MACHINE LEARNING IN COMMUNICATION NETWORKS

(71) Applicant: T-MOBILE INNOVATIONS LLC, Overland Park, KS (US)

(72) Inventors: Roy Vincent Monsalud, Downers Grove, IL (US); Maria Victoria Cabamalan, Covington City, WA (US)

(21) Appl. No.: 18/970,423

(22) Filed: Dec. 5, 2024

(51) Int. Cl. H04L 9/40; G06N 20/00

(52) U.S. Cl. CPC H04L 63/1416; G06N 20/00

(57) ABSTRACT

Various embodiments include a system that comprises a network analytics system and a machine learning engine. The analytics system obtains network performance data associated with one or more device setup operations and service delivery data associated with one or more session setup operations from network entities. The analytics system generates feature vectors that include dimensions that represent the data. The machine learning engine is trained to correlate one or more anomalous device setup operations with one or more anomalous session setup operations. The machine learning engine ingests the vectors and generates an output that indicates at least one anomalous session setup operation, at least one anomalous device setup operation that correlates to the at least one anomalous session setup operation, and that identifies one or more network entities associated with the anomaly based at least on the vectors. The engine surfaces an alert to network operators based on the output.

### TECHNICAL FIELD

Various embodiments of the present technology relate to machine learning, and more specifically, to utilizing machine learning to detect service disruptions in communication networks.

### BACKGROUND

Wireless communication networks provide wireless data services to wireless user devices. Exemplary wireless data services include machine-control, internet-access, media-streaming, online gaming, and social-networking. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Machine learning algorithms are designed to recognize patterns and automatically improve through training and the use of data. Examples of machine learning algorithms include artificial neural networks, nearest neighbor methods, gradient-boosted trees, ensemble random forests, support vector machines, naïve Bayes methods, and linear regressions. Some machine learning models comprise supervised learning models. A supervised machine learning algorithm comprises an input layer and an output layer, wherein complex analyzation takes places between the two layers. Various training methods are used to train machine learning algorithms wherein an algorithm is continually updated and optimized until a satisfactory model is achieved. One advantage of supervised learning machine learning algorithms is their ability to learn by example, rather than needing to be manually programmed to perform a task, especially when the tasks would require a near-impossible amount of programming to perform the operations in which they are used.

Wireless communication networks utilize machine learning models to predict network conditions, provide recommendations to network operators, drive innovation, and perform other machine learning assisted tasks. For the models to be effective, they are trained using large amounts of network data that depicts network performance, fault management responses, and network configurations. Once trained the models may anticipate network needs to autonomously adapt operation, or even identify new features for existing systems that may enhance system performance while reducing operational expenses. To train the models, wireless networks collect data from the network functions in the network. The data characterizes the operations performed by the network functions. Exemplary operations include registration, authentication/authorization, session establishment, call establishment, and the like. However, in some instances, aggregating the network function data for the models is difficult due to the large volume of data and the large number of network functions and network function types in the network. The inefficient data aggregation increases the number of machine learning models needed to process the data.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network anomaly detection. Some embodiments comprise a method. The method comprises obtaining, by a network analytics system, network performance data associated with one or more device setup operations and service delivery data associated with one or more session setup operations from network entities in a communication network. The method further comprises generating, by the network analytics system, feature vectors that include dimensions that represent the network performance data and the service delivery data. The method further comprises ingesting, by a machine learning engine, the feature vectors. The machine learning engine is trained to correlate one or more anomalous device setup operations with one or more anomalous session setup operations. The method further comprises generating, by the machine learning engine, a machine learning output that indicates at least one anomalous session setup operation, at least one anomalous device setup operation that correlates to the at least one anomalous session setup operations, and that identifies one or more of the network entities associated with the at least one anomalous operation based at least on the feature vectors. The method further comprises surfacing, by the machine learning engine, an alert to network operators based on the machine learning output.

Some embodiments comprise a system. The system comprises a network analytics system and a machine learning engine. The network analytics system obtains network performance data associated with one or more device setup operations and service delivery data associated with one or more session setup operations from network entities in a communication network. The network analytics system generates feature vectors that include dimensions that represent the network performance data and the service delivery data. The machine learning engine is trained to correlate one or more anomalous device setup operations with one or more anomalous session setup operations. The machine learning engine ingests the feature vectors and generates a machine learning output that indicates at least one anomalous session setup operation, at least one anomalous device setup operation that correlates to the at least one anomalous session setup operation, and that identifies one or more of the network entities associated with the at least one anomalous operation based at least on the feature vectors. The machine learning engine surfaces an alert to network operators based on the machine learning output.

Some embodiments comprise one or more non-transitory computer readable storage media having program instructions stored thereon. When executed by a computing system, the program instructions direct the computing system to perform operations. The operations comprise obtaining network performance data associated with one or more device setup operations and service delivery data associated with one or more session setup operations from network entities in a communication network. The operations further comprise generating feature vectors that include dimensions that represent the network performance data and the service delivery data. The operations further comprise utilizing a machine learning engine trained to correlate one or more anomalous device setup operations with one or more anomalous session setup operations to ingest the feature vectors and generate a machine learning output that indicates at least one anomalous session setup operation, at least one anomalous device setup operation, and that identifies one or more of the network entities associated with the at least one anomalous operation based at least on the feature vectors. The operations further comprise surfacing an alert to network operators based on the machine learning output.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an exemplary communication network to utilize machine learning to detect service anomalies.

FIG. 2 illustrates an exemplary operation of the communication network to utilize machine learning to detect service anomalies.

FIG. 3 illustrates another exemplary operation of the communication network to utilize machine learning to detect service anomalies.

FIG. 4 illustrates exemplary network elements in the communication network to utilize machine learning to detect service anomalies.

FIG. 5 illustrates an exemplary Fifth Generation (5G) communication network to utilize machine learning to detect service anomalies.

FIG. 6 illustrates exemplary network functions in the 5G communication network to utilize machine learning to detect service anomalies.

FIG. 7 illustrates an exemplary 5G data center and Internet Protocol Multimedia Subsystem (IMS) data center in the 5G communication network to utilize machine learning to detect service anomalies.

FIG. 8 further illustrates the 5G data center in the 5G communication network to utilize machine learning to detect service anomalies.

FIG. 9 further illustrates the IMS data center in the 5G communication network to utilize machine learning to detect service anomalies.

FIG. 10 illustrates an exemplary operation of the 5G communication network to utilize machine learning to detect service anomalies.

FIG. 11 illustrates another exemplary operation of the 5G communication network to utilize machine learning to detect service anomalies.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

In conventional wireless communication networks, analytics systems like Network Data Analytics Function (NWDAF) collect data and generate analytics from other elements of the network. The analytics systems provide the data to machine learning models for training, network condition prediction, and network operation suggestion. The number of elements and network element types that provide data to the analytics systems is large. Exemplary network elements include the Radio Access Network (RAN), control plane network functions like Access and Mobility Management Function (AMF), Session Management Function (SMF), Policy Control Function (PCF), Mobility Management Entity (MME), Policy and Rules Charging Function (PCRF), user plane functions like User Plane Function (UPF), Packet Gateway (P-GW), and Serving Gateway (S-GW), and Internet Protocol Multimedia Subsystem (IMS). The data reported by the network elements typically characterizes their operations in the network. The network analytics systems do not effectively aggregate this data due to its large and diverse nature. The failure to effectively aggregate the data increases the number of machine learning models needed to process the data. For example, current communication networks may utilize a first model to analyze AMF registration operations and utilize a second machine learning model to analyze AMF session modification operations. The use of multiple machine learning models decreases overall network efficiency.

To overcome the above-described problems in conventional wireless communication networks, various embodiments of the present technology relate to utilizing machine learning models to correlate anomalous network operations with anomalous service delivery. A network analytics system obtains operations data and service delivery data from network entities in the communication network. The operations data characterizes device setup operations like registration and session establishment while the service delivery data characterizes operations like voice/video call delivery and data session delivery. The analytics system organizes the operations data and service delivery data into Key Performance Indicators (KPIs). Each KPI comprises a node type, node Identifier (ID), operation type, and either a success rate for the operation or a count for the operation. By organizing the operations and service delivery data into KPIs for success rate and count, the analytics system reduces the number of machine learning models needed to process, interpret, and generate responses for the data. The analytics system converts the KPIs into feature vectors and provides the feature vectors to models trained to correlate anomalous network operations with anomalous service delivery based on the success rates and counts indicated by the KPIs. The models produce outputs that indicate when anomalous network operations and anomalous service delivery are detected. The models surface the outputs to network operators to respond to the detected anomalies. Now referring to the Figures.

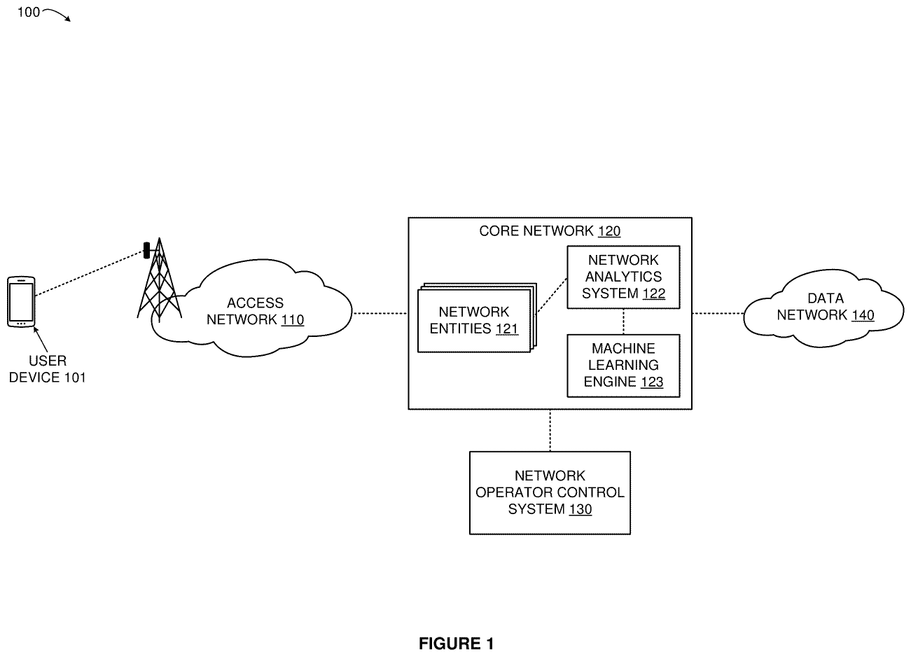

FIG. 1 illustrates communication network 100 to utilize machine learning to detect service anomalies. Communication network 100 provides services like media-streaming, internet-access, voice/video calling, text messaging, online gaming, social media, machine communications, or some other wireless communications product. Communication network 100 comprises user device 101, access network 110, core network 120, network operator control system 130, and data network 140. Core network 120 comprises network entities 121, network analytics system 122, and machine learning engine 123. In other examples, communication network 100 may comprise additional or different elements than those illustrated in FIG. 1.

Various examples of network operation and configuration are described herein. In some examples, user device attaches to core network 120 over access network 110. User device 101 interfaces with network entities 121 to register for service on communication network 100. Network entities 121 authenticate and authorize user device 101. Responsive to authentication and authorization, network entities 121 register user device 101 and indicate the successful registration to user device 101 over access network 110. User device 101 begins a session on communication network 100. User device 101 exchanges user data with network entities 121 over access network 101. Network entities 121 exchanges the user data with data network 140. Exemplary session types include data sessions, media streaming/broadcasting sessions, voice/video multimedia sessions, Voice over New Radio (VoNR) calls, Voice over Long Term Evolution (VoLTE) calls, gaming sessions, and the like.

Network analytics system 122 collates information in core network 120. Network analytics system 122 is subscribed to network entities 121 for data reporting. Network entities 121 report their respective data to network analytics system 122. The data comprises network performance data and service delivery data. The network performance data characterizes one or more device setup operations performed by network entities 121 and the service delivery data characterizes one or more session setup operations for user device 101. Exemplary device setup operations include registration, session establishment, authentication/authorization, user device signaling, user device paging, session modification, tracking area updating, and the like. Exemplary session setup operations include data exchange, data routing, voice call delivery, video call delivery, data rate delivery, data latency delivery, data throughput delivery, and the like. Network analytics system 122 generates feature vectors to numerically represent the network performance data and the service delivery data. A feature vector is a numeric representation of data interpretable by a machine learning model. A feature vector comprises a string of numbers (i.e., a vector) where each number represents some aspect of the data. Each of these numbers is referred to as a dimension. The number of dimensions in a feature vector is arbitrary and depends in part on the capabilities of the machine learning model and the characteristics of the data. For example, network analytics system 122 may generate a feature vector with dimensions that represent network entity type (e.g., AMF), network entity ID (e.g., AMF ID), network entity operation type (e.g., registration), network entity operation success rate (registration success rate), and network entity operation count (e.g., number of registrations performed). Network analytics system 122 provides the feature vectors to machine learning engine 123.

Machine learning engine 123 comprises one or more machine learning algorithms trained to correlate one or more anomalous device setup operations with one or more anomalous session setup operations. Machine learning engine 123 ingests the feature vectors and processes the feature vectors with its constituent machine learning algorithms. Machine learning engine 123 produces an output that indicates at least one anomalous device setup operation, at least one session setup operation that correlate to the at least one anomalous device setup operation, and identifies one or more of network entities 121 associated with the at least one anomalous operation based at least on the feature vectors. For example, the output may identify one of network entities 121, indicate the network entity performed an erroneous session modification, and indicate the bitrate to user device 101 is degraded as a result of the erroneous session modification. When the output indicates anomalous behavior and service delivery, machine learning engine 123 surfaces the output to network operator control system 130. Network operator control system 130 presents output to network operators and receives a user input(s) that comprises signaling to correct the anomalous behavior. Network operator control system 130 loads the signaling to the anomalously behaving one(s) of network entities 121 identified in the output.

Advantageously, communication network 100 efficiently prepares data to train and use machine learning models. Moreover, communication network 100 effectively utilizes machine learning models to correlate anomalous network function operation with service delivery disruptions.

User device 101 may comprise a vehicle, drone, robot, computer, phone, sensor, or another type of data appliance with wireless and/or wireline communication circuitry. User device 101 and access network 110 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies may use electromagnetic frequencies in the low-band, mid-band, high-band, or some other portion of the electromagnetic spectrum. The wired connections may comprise metallic links, glass fibers, and/or some other type of wired interface.

Although access network 110 is illustrated as comprising a tower, access network 110 may comprise another type of mounting structure (e.g., a building), or no mounting structure at all. Access network 110 may comprise a Sixth Generation (6G) Radio Access Network (RAN), Fifth Generation (5G) RAN, LTE RAN, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. While access network 110 is illustrated as a terrestrial system, in some examples access network 110 may comprise a non-terrestrial (e.g., satellite) based access network. Access network 110 may exchange network signaling and user data with network functions clustered together into core network 120. Access network 110 is connected to core network 120 over backhaul data links. Access network 110 and core network 120 may communicate via edge networks like internet backbone providers, edge computing systems, or another type of edge system to provide the backhaul data and signaling links between access network 110 and core network 120.

Access network 110 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120.

Core network 120 is representative of computing systems that provide wireless data services to user device 101 over access network 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access network 110, core network 120, network operator control system 130, and data network 140 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 120 store and execute the network functions/entities to form network entities 121, network analytics system 122, and machine learning engine 123. The functions/entities are typically organized into a control plane and a user plane. The control plane may comprise network functions/entities like AMF, SMF, PCF, Unified Data Management (UDM), MME, Home Subscriber Server (HSS), PCRF, and the like. The user plane may comprise network functions like UPF, S-GW, P-GW, and the like. Network analytics system 122 may comprise network functions like Network Data Analytics Function (NWDAF) and Analytics Data Repository Function (ADRF).

Machine learning engine 123 comprises any machine learning model implemented within communication network 100 to detect anomalous network activity, correlate the anomalous network activity to service disruptions, rectify the anomalous network activity, alert network operators, and/or perform some other type of machine learning assisted task. Machine learning engine 123 may comprise a network function like Machine Learning Function (MLF). A machine learning model comprises one or more machine learning algorithms that are trained based on historical data and/or other types of training data. A machine learning model may employ one or more machine learning algorithms through which data can be analyzed to identify patterns, make decisions, make predictions, or similarly produce output. Examples of machine learning algorithms that may be employed solely or in conjunction with one another include time series models, Large Language Models (LLMs), Three Dimensional (3D) deep leaning models, 3D convolutional neural networks, times series convolutional deep learning, transformers, multi-layer perceptron, long term short memory, and attention based deep learning model. Other exemplary machine learning algorithms include artificial neural networks, nearest neighbor methods, ensemble random forests, support vector machines, naïve Bayes methods, linear regressions, or similar machine learning techniques or combinations thereof capable of predicting output based on input data.

Network operator control system 130 is representative of a computing system that allows human operators to control, affect, or otherwise influence communication network 100. For example, network operator control system 130 may load an update to one or more of network entities 121 to correct anomalous behavior in response to receiving an alert from machine learning engine 123. Network operator control system 130 may comprise an Orchestration and Management (OAM) system and the like. Data network 140 comprises an Application Server (AS) that hosts applications (e.g., media streaming applications, social media applications, IoT applications, online gaming applications, etc.) for user device 101. Data network 140 may be representative of a public data network (e.g., the Internet) or a private data network (e.g., an enterprise network).

User device 101 and access network 110 may comprise antennas, amplifiers, filters, modulation, analog/digital interfaces, microprocessors, software, memories, transceivers, bus circuitry, and the like. User device 101, access network 110, core network 120, network operator control system 130, and data network 140 may comprise microprocessors, software, memories, transceivers, bus circuitry, and the like. The microprocessors may comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories may comprise Random Access Memory (RAM), Solid State Drives (SSDs), Hard Disk Drives (HDDs), Non-Volatile Memory Express (NVMe) SSDs, and/or the like. The memories may store software like operating systems, user applications, radio applications, and network functions. The microprocessors may retrieve the software from the memories and execute the software to drive the operation of communication network 100 as described herein.

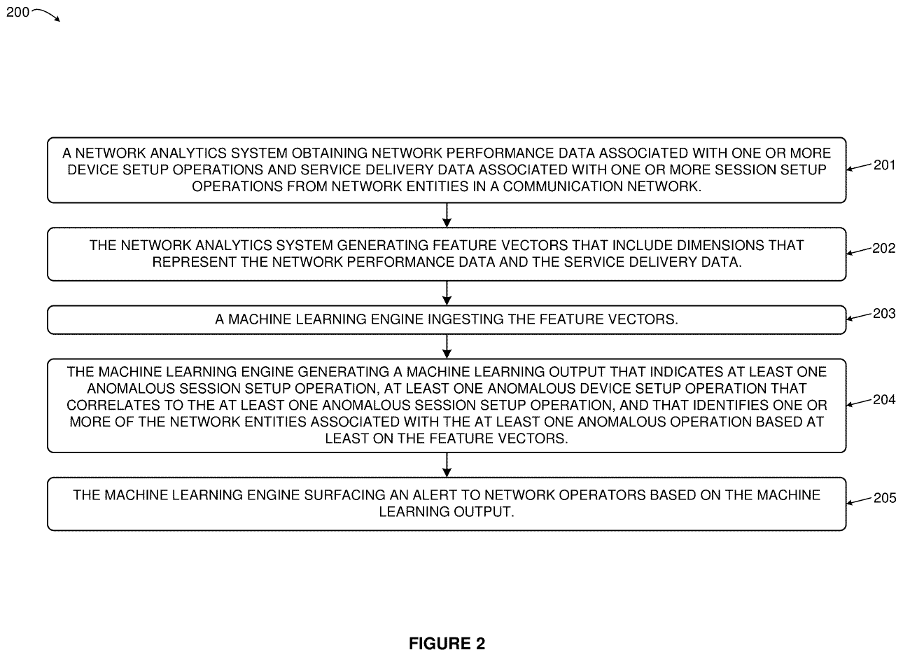

FIG. 2 illustrates process 200. Process 200 comprises an exemplary operation of communication network 100 to utilize machine learning to detect service anomalies. Process 200 may vary in other examples. The operations of process 200 comprise a network analytics system obtaining network performance data associated with one or more device setup operations and service delivery data associated with one or more session setup operations from network entities in a communication network (step 201). The operations further comprise the network analytics system generating feature vectors that include dimensions that represent the network performance data and the service delivery data (step 202). The operations further comprise a machine learning engine ingesting the feature vectors (step 203). The machine learning engine is trained to correlate one or more anomalous device setup operations with one or more anomalous session setup operations based at least on the feature vectors. The operations further comprise the machine learning engine generating a machine learning output that indicates at least one anomalous session setup operation, at least one anomalous device setup operation that correlates to the at least one anomalous session setup operation, and that identifies one or more of the network entities associated with the at least one anomalous operation based at least on the feature vectors (step 204). The operations further comprise the machine learning engine surfacing an alert to network operators based on the machine learning output (step 205).

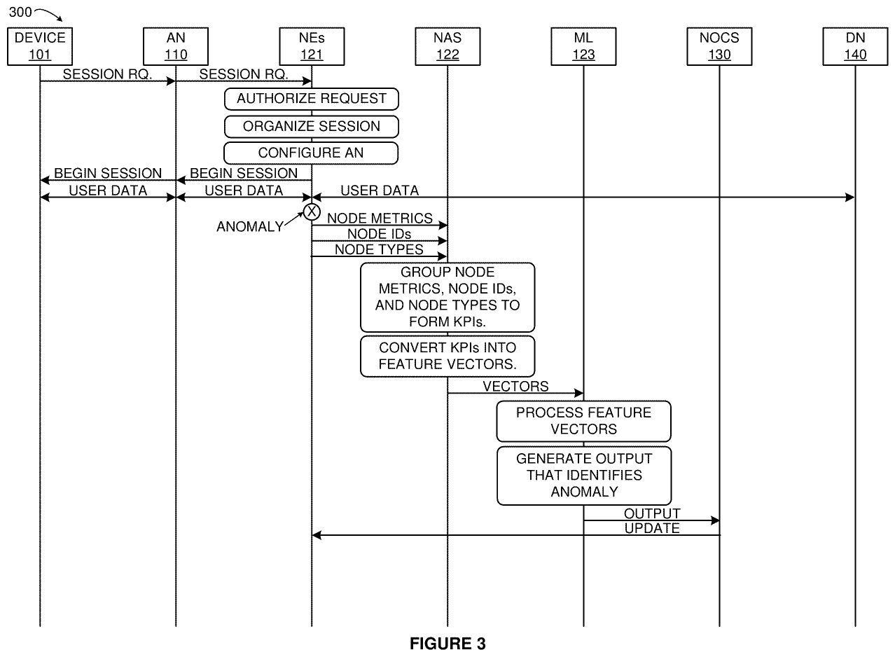

FIG. 3 illustrates process 300. Process 300 comprises an exemplary operation of communication network 100 to utilize machine learning to detect service anomalies. Process 300 comprises an example of process 200 illustrated in FIG. 2, however process 200 may differ. Process 300 may vary in other examples. In some examples, user device 101 transfers a session request to network entities (NEs) 121 over access network (AN) 110. Network entities 121 interface with each other to authorize the request and organize the session. For example, network entities 121 may access a subscriber profile for user device 101 and determine if user device 101 is subscribed to receive the requested session type. Responsive to session authorization and organization, network entities 121 configure access network 110 to serve the session to user device 101. Network entities 121 transfer a begin session command to user device 101 over access network 110. User device 101 receives the command and begins the session. User device 101 exchanges user data with network entities 121 over access network 110. Network entities 121 exchange the user data with data network 140. During the device setup and service delivery to user device 101, an anomaly occurs in one of network entities 121 that adversely affects the user data exchange with user device 101. For example, the anomalously behaving network entity may erroneously deactivate a data bearer for user device 101 which lowers the throughput for user device 101's session.

Network entities 121 stream node metrics, node IDs, and node types to network analytics service (NAS) 122. The node metrics comprise network performance data and service delivery data. The network performance data characterizes the device setup operations (e.g., registration, authentication/authorization, session organization, AN configuration, etc.) performed by network entities 121. The service delivery data characterizes session setup operations (e.g., session QoS, session bitrate, session throughput, session latency, etc.) performed by network entities 121. The node IDs indicate individual ones of network entities 121. The node types indicate the types (e.g., AMF, MME, SMF, PCF, etc.) for ones of network entities 121. Network analytics system 122 groups the node metrics, node IDs, and node types to form device setup KPIs and session setup KPIs. For example, network entities 121 may comprise AMFs, and network analytics system 122 may form KPIs for registration success rate and registration count for one of the AMFs. Network analytics system 122 converts the device setup and session KPIs into device setup feature vectors and service setup feature vectors. The dimensions of the feature vectors represent the node type, node ID, node operation type, and either operation success rate or operation count for the node operation types. Network analytics system 122 provides the feature vectors to machine learning engine (ML) 123.

Machine learning engine 123 ingests and processes the feature vectors using its constituent machine learning algorithms to correlate anomalous device setup operations with anomalous session setup operations. Machine learning engine 123 generates an output that indicates an anomalous device setup operation, indicates the resulting anomalous session setup operation, and identifies the one of network entities 121 associated with the anomalous device setup operation. Machine learning engine 123 provides the output to network operator control system (NOCS) 130. Network operator control system 130 alerts network operators and displays the output. Network operator control system 130 receives a software update from the network operators to correct the anomalous network entity behavior and restore the service delivery to user device 101. Network operator control system 130 loads the update to the one of network entities 121 exhibiting anomalous behavior.

In some examples, network analytics system 122 may train the model(s) of machine learning system to detect anomalous network behavior based on historical data. Network analytics system 122 receives historical network performance data and historical service delivery data from network entities 121. The historical performance data characterizes historical device setup operations, and the historical service delivery characterizes historical session setup operations from network entities. Network analytics system 122 generates training feature vectors. The dimensions of the training feature vectors represent the historical network performance data and the historical service delivery data. Network analytics system 122 provides the training feature vectors to machine learning engine 123. Machine learning engine 123 ingests the training feature vectors and processes the training vectors using its constituent machine learning algorithms. Machine learning engine 123 generates a training machine learning output that predicts when the historical session setup operations are anomalous, that predicts when the historical device setup operations are anomalous, and that predicts the one or more of the network entities associated with the historical anomalous device setup operations. Machine learning engine 123 compares the training machine learning output to the historical network performance data and the historical service delivery data to determine the training state of its machine learning algorithms. In particular, machine learning engine 123 assesses the accuracy of the predictions to determine the training state. Machine learning engine 123 adjusts its constituent machine learning algorithms (e.g., adjusts algorithm weights) based on the training state to improve its prediction accuracy. Once its training state is sufficient, machine learning engine 123 may be pushed to production.

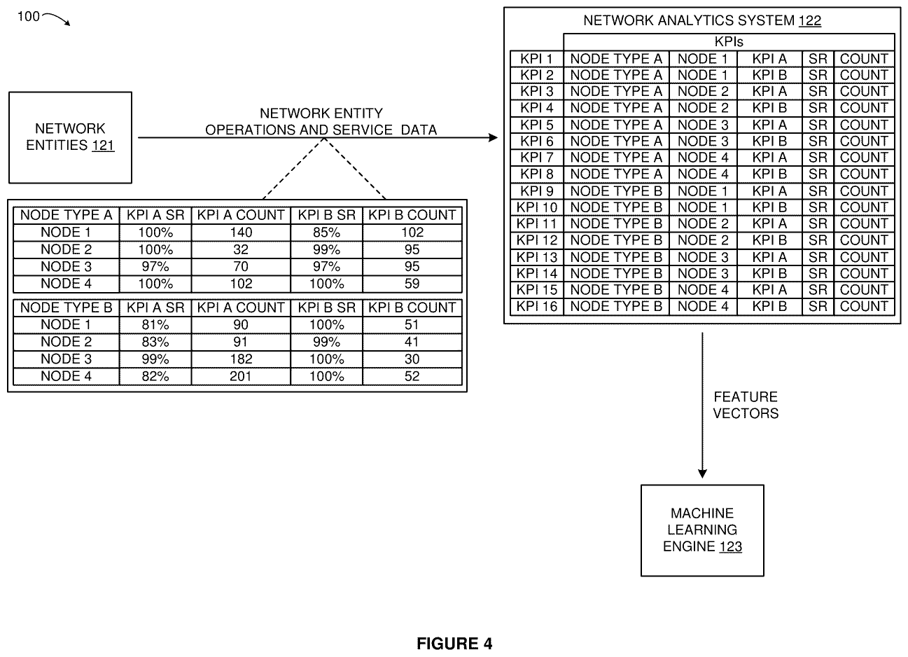

FIG. 4 further illustrates network entities 121, network analytics system 122, and machine learning engine 123 in communication network 100. In some examples, network entities 121 transfer network entity operations and service data to network analytics system 122. The data is organized by node type, KPI success rate (SR), and KPI count. As illustrated in FIG. 4, the network entity data comprises node type A and node type B, KPI success rate A, KPI A count, KPI success rate B, and KPI B count. Node type A comprises nodes 1-4 and node type B comprises nodes 1-4. For example, node type A may comprise SMF and nodes 1-4 of node type A may comprise SMF IDs for four SMF instances in core network 120. KPIs A and B represent operation types performed by nodes 1-4 of node types A and B. For example, KPI A may comprise user device registration, KPI B may comprise session establishment requests. In this case, node 1 of node type A would have a registration success rate of 100%, 140 registrations performed, a session establishment request success rate of 85%, and 102 session establishment requests performed.

Network analytics system 122 receives the network entity data and generates KPIs to represent the network entity operations and service data. Network analytics system 122 groups the network entity data by node type, node ID (e.g., node 1), KPI type (e.g., KPI A and KPI B), success rate, and count. As illustrated in FIG. 4, network analytics system 122 generates KPIs 1-16 from the network entity data. Network analytics system 122 converts the KPIs into feature vectors interpretable by machine learning engine 123 and with dimensions that represent the node types, node IDs, KPI types, KPI success rates, and KPI counts. Network analytics system 122 transfers the feature vectors to machine learning engine 123. Machine learning engine 123 processes the feature vectors and generates a machine learning output that indicates when service delivery to user device 101 is anomalous and identifies one or more of network entities 121 that are causing the anomaly. Advantageously, by grouping the node type, node ID, KPI type, KPI success rate, and KPI count into KPIs, network analytics system 122 reduces the number of machine learning models needed to detect anomalous service delivery and identify network entity behavior causing the anomalous service delivery.

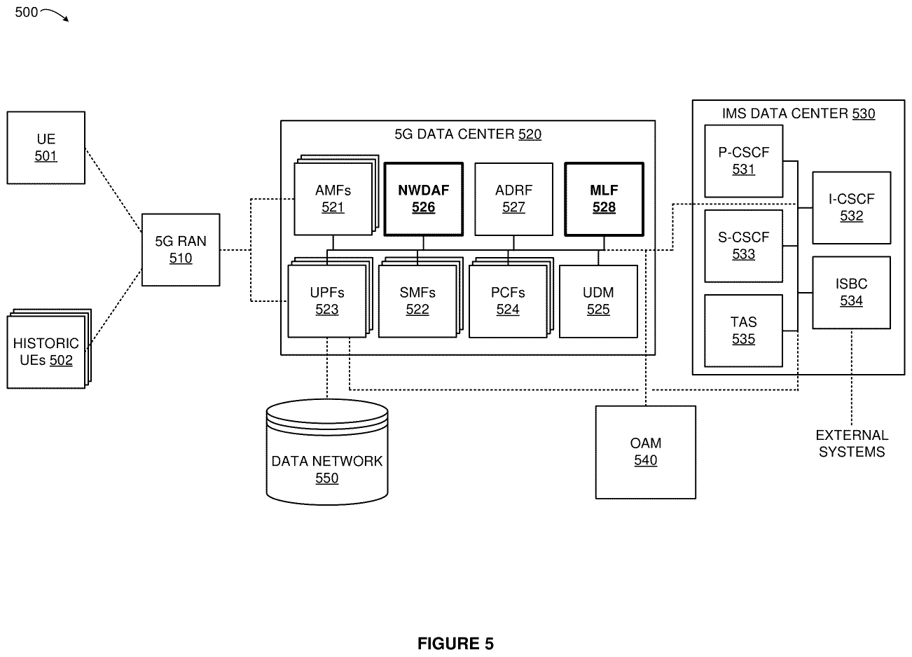

FIG. 5 illustrates 5G communication network 500 to utilize machine learning to detect service anomalies. 5G communication network 500 comprises an example of communication network 100 illustrated in FIG. 1, however communication network 100 may differ. 5G communication network 500 comprises 5G User Equipment (UE) 501, historic UEs 502, 5G RAN 510, 5G data center 520, IMS data center 530, OAM 540, and data network 550. 5G data center 520 comprises AMFs 521, SMFs 522, UPFs 523, PCFs 524, UDM 525, NWDAF 526, ADRF 527, and MLF 528. Other network functions and network entities like Authentication Server Function (AUSF), Unified Data Registry (UDR), Network Slice Selection Function (NSSF), Charging Function (CHF), Home Subscriber Register (HLR), Home Subscriber Server (HSS), Network Repository Function (NRF), Short Message Service Function (SMSF), Network Exposure Function (NEF), Application Function (AF), Equipment Identity Register (EIR), and Session Communication Proxy (SCP) are typically present in 5G data center 520 but are omitted for clarity. IMS data center 530 comprises Proxy Call Session Control Function (P-CSCF) 531, Interrogating Call Session Control Function (I-CSCF) 532, Serving Call Session Control Function (S-CSCF) 533, Interconnect Session Border Controller (ISBC) 534, and Telephony Application Server (TAS) 535. Other IMS functions and IMS entities like Short-Message-Service Application Server (SMS AS), Rich Communication Service AS (RCS AS), Breakout Gateway Control Function (BGCF), and E.164 Number Mapping (ENUM) are typically present in IMS data center 530 but are omitted for clarity. In other examples, 5G communication network 500 may comprise different or additional elements than those illustrated in FIG. 5.

In some examples, historic UEs 502 attach to 5G data center 520 via 5G RAN 510. Historic UEs 502 transfer registration requests to AMFs 521. AMFs 521 interface with UDM 525 to authenticate and authorize historic UEs 502 for service on 5G communication network 500. AMFs 521 request context for historic UEs 502 from UDM 525. UDM 525 accesses subscriber profiles for historic UEs 502 and returns subscriber attributes (e.g., QoS, allowed slices, max/min latency, max/min throughput, bitrate, etc.) that describes the service level to historic UEs 502. AMFs 521 generate UE context for historic UEs 502 based on the retrieved subscriber attributes. PCFs 524 provides network policies for historic UEs 502 to AMFs 521. AMFs 521 interface with SMFs 522 to select ones of UPFs 523 to serve historic UEs 502 based on their UE context and network policies. SMFs 522 control UPFs 523 to serve historic UEs 502 based on their UE context and network policies. AMFs 521 register historic UEs 502 for service and transfer registration accept messages to historic UEs 502 over 5G RAN 510 to indicate the successful registrations.

In response to successful network registration, historic UEs 502 transfer IMS registration requests to P-CSCF 531 over their respective ones of UPFs 523. P-CSCF 531 forwards the requests to I-CSCF 532. I-CSCF 532 performs a Domain Name Service (DNS) query to select S-CSCF 533 and forwards to the requests to S-CSCF 533. S-CSCF 533 interfaces with UDM 525 and PCFs 524 to authenticate and authorize historic UEs 502 for IMS service. Responsive to successful authentication and authorization, S-CSCF 533 registers historic UEs 502 and transfers IMS registration accept messages to historic UEs 502 over P-CSCF 531 and UPFs 523.

Historic UEs 502 send/receive Session Initiation Protocol (SIP) messages to engage in voice/video multimedia calls with other UEs to P-CSCF 531. P-CSCF 531 provides the SIP messages to S-CSCF 533. S-CSCF 533 routes the SIP messages to external systems over ISBC 534 to the other UEs. Upon acceptance of the SIP messages, the voice/video multimedia sessions between historic UEs 502 and the other UEs may begin. S-CSCF 533 notifies SMFs 522. SMFs 522 retrieve network policies (e.g., QoS rules, bitrate rules, etc.) from PCF 524 for the multimedia calls. SMFs 522 direct UPFs 523 to support the multimedia calls and notifies AMFs 521 that the user plane is ready to support the calls. AMFs 521 transfers a PDU session resource modify request to 5G RAN 510 to direct 5G RAN 510 to support the multimedia calls for historic UE. 5G RAN 510 allocates radio resources for the multimedia calls and notifies historic UEs 502 to begin the multimedia calls. Historic UEs 502 exchange data packets with the other UEs over UPFs 523, ISBC 534, and the external systems. SMFs 522, S-CSCF 533, and TAS 535 monitor the packet exchange to support the voice/video calls.

NWDAF 526 is subscribed for KPI reporting from AMFs 521, SMFs 522, UPFs 523, PCFs 524, P-CSCF 531, S-CSCF 533, TAS 535, and ISBC 534. AMFs 521 report KPIs like registrations, PDU establishment requests, PDU session resource modifications, Tracking Area Update (TAU) messaging, NGAP requests, paging, and service requesting. SMFs 522 report KPIs like N1/N2 message transfer, session establishment, and session modification. UPFs 523 report KPIs like Fifth Generation Quality of Service Indicator (5QI) bearer drops and IMS bearer drops. PCFs 524 report KPIs like call authorization request receiving and call authorization request responding. S-CSCF 533, TAS 535, and ISBC 534 report KPIs like SIP create session requesting. P-CSCF 531 reports KPIs like SIP create session requesting and SIP call terminating. NWDAF 526 receives the KPIs and groups the received KPIs by network function type, network function ID, KPI type, and success rate to generate success rate training KPIs. NWDAF 526 also groups the received KPIs by network function type, network function ID, KPI type, and count to generate count training KPIs. For example, NWDAF 526 may generate a KPI that comprises an AMF network function type, AMF ID, registration KPI, and registration success rate. NWDAF 526 loads the training KPIs to ADRF 527.

MLF 528 initiates a training process for its constituent machine learning models. MLF 528 retrieves the KPIs from ADRF 527. MLF 528 performs a feature extraction process on the KPIs to generate training feature vectors that numerically represent the training KPIs. MLF 528 provides the training feature vectors that represent the success rate KPIs to a first machine learning model to train the model to detect anomalous success rate. MLF 528 provides the training feature vectors that represent the count KPIs to a second machine learning model to train the model to detect anomalous network function operation counts. MLF 528 may provide the KPIs to a third machine learning model to train the model to recommend responses and generate corrective signaling in response to anomaly detection by the first and second models. The training processes may be unsupervised or supervised. In general, the first and second models are trained to determine baseline network function operation success rates and baseline network function operation counts. The models can use these baselines to detect anomalous network function behavior and correlate these anomalies to anomalous voice call and/or other service delivery (e.g., PDU session serving) when the network function operation success rates/counts deviate a statistically significant amount (e.g., 5%) from the baselines. The models typically comprise time series models, however other models may be used. Once training is finished, MLF 528 pushes the models to production.

UE 501 wirelessly attaches to 5G RAN 510 over a 5GNR link. UE 501 undergoes a Random Access Channel (RACH) procedure with 5G RAN 510 to establish a secure signaling channel. UE 501 transfers a registration request to one of AMFs 521 over 5G RAN 510. The registration request indicates a registration type, 5G-Global Unique Temporary Identifier (GUTI), Tracking Area Identifier (TAI), Network Slice Selection Assistance Information (NSSAI) requests, UE capabilities, PDU session requests, and the like.

In response to the registration request, the one of AMFs 521 transfers a Non-Access Stratum (NAS) identity request to UE 501 over 5G RAN 510. UE 501 indicates its Subscriber Concealed Identifier (SUCI) to the one of AMFs 521 over 5G RAN 510. The one of AMFs 521 transfers an authentication request to UDM 525, typically over an AUSF, to retrieve authentication vectors to authenticate UE 501. The request comprises the SUCI for UE 501. UDM 525 accesses the subscriber profile for UE 501 (typically stored on a UDR) and derives the Subscriber Permanent Identifier (SUPI) for UE 501 based on the SUCI. UDM 525 generates authentication vectors for UE 501 and returns the vectors and SUPI for delivery to the one of AMFs 521. The authentication vectors comprise a random number, expected result, key selection criteria, and the like. The one of AMFs 521 transfers an authentication challenge that comprises the random number and key selection criteria to UE 501 over the NAS link that traverses 5G RAN 510. UE 501 hashes the random number with its secret key to generate an authentication result and indicates the authentication result to the one of AMFs 521 over 5G RAN 510. The one of AMFs 521 matches the expected result with the authentication result received from UE 501 to authenticate UE 501.

Responsive to the authentication, the one of AMFs 521 transfers a context registration request to UDM 525 that includes AMF ID, a supported feature list, a Permanent Equipment Identifier (PEI) for UE 501, and the like. UDM 525 indicates successful UDM registration to the one of AMFs 521. In response, the one of AMFs 521 requests access and mobility subscription data, SMF selection subscription data, and UE context in SMF data from UDM 525. UDM 525 accesses the subscriber profile for UE 501 and returns the requested data. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. The one of AMFs 521 forms the UE context for UE 501 using the retrieved information. The UE context defines the authorized services for UE 501.

The one of AMFs 521 transfers a policy creation request to one of PCFs 524 to create a policy association for UE 501. The one of PCFs 524 responds to the request with policy association information like the SUPI, GPSI, PEI, and user location information for UE 501. The one of PCFs 524 subscribes to the one of AMFs 521 for event reporting like user location updates, registration state changes, communication failure events, and the like. The one of AMFs 521 creates a PCF subscription based on the policy association information and signals the one of PCFs 524 of the successful subscription creation.

The one of AMFs 521 selects one of SMFs 522 to serve UE 501 based on the SMF selection data received from UDM 525, the network policies received from the one of PCFs 524, and/or the network slice assigned to UE 501. The one of AMFs 521 transfers a list of requested PDU sessions (as received during the registration request), a PDU session activation command, and the SUPI to the selected one of SMFs 522. The one of SMFs 522 receives the PDU session list, session activation command, and the SUPI from the one of AMFs 521. The one of SMFs 522 allocates IP addresses to UE 501 for the requested PDU sessions and allocates a TEID for the session. The one of SMFs 522 selects one of UPFs 523 based on the UE context. The one of SMFs 522 transfers a session modification request that includes a session endpoint identifier, IP address, MSISDN, session start/stop information, and TEID to the selected one of UPFs 523 to set up the PDU sessions for UE 501. The selected one of UPFs 523 creates data bearers for UE 501 that traverse 5G RAN 510.

The one SMFs 522 returns a PDU session create response to the one of AMFs 521 to confirm session creation. In response, the one of AMFs 521 registers UE 501 for service on 5G data center 520. The one of AMFs 521 generates a registration accept message that includes the allocated UE IP address, RAN ID, AMBR, Globally Unique AMF ID (GUAMI), PDU session ID, PDU session TEID, allowed NSSAI list, security data, and the like. The one of AMFs 521 transfers the registration accept message to UE 501 over 5G RAN 510. UE 501 receives the registration accept message. Once registered, UE 501 may participate in PDU sessions over 5G communication network 500. For example, UE 501 may exchange user data for a PDU session with the one of UPFs 523 over 5G RAN 510. The one of UPFs 523 may exchange the user data with data network 550.

In response to successful network registration, UE 501 generates an IMS registration request to register for IMS services like voice calling from IMS data center 530. UE 501 addresses the registration request for P-CSCF 531 and transfers the IMS registration request to 5G RAN 510. 5G RAN 510 forwards the IMS registration request to the one of UPFs 523. The one of UPFs 523 reads the network address for P-CSCF 531 in the IMS registration request and forwards the request to P-CSCF 531. P-CSCF 531 performs a DNS query to determine the network address for I-CSCF 532 and forwards the registration request to I-CSCF 532. I-CSCF 532 interfaces with UDM 525 to identify and select S-CSCF 533. I-CSCF 532 forwards the IMS registration request to S-CSCF 533. S-CSCF 533 exchanges authentication signaling with UE 501 and UDM 525 to authenticate and authorize UE 501 for IMS services. For example, UDM 525 may access the subscriber profile for UE 501 to determine if UE 501 qualifies for IMS service and may indicate the qualification to S-CSCF 533. Upon authentication and authorization, S-CSCF 533 registers UE 501 for IMS service. S-CSCF 533 notifies P-CSCF 531 which transfers a registration accept message to UE 501 over UPF 523 and RAN 510.

Once registered with IMS data center 530, UE 501 initiates an IMS voice session with another UE (not illustrated). UE 501 generates a SIP invite message that includes the public Uniform Resource Indicator (URI) for the called UE. UE 501 transfers the SIP invite to 5G RAN 510 which forwards the SIP invite to the one of UPFs 523 which in turn delivers the SIP invite message to P-CSCF 531. P-CSCF 531 receives the SIP invite and forwards the invite to S-CSCF 533. S-CSCF 533 receives the SIP invite and notifies TAS 535 of the requested voice session. S-CSCF 533 translates the URI for the called UE included into its registered IP address. S-CSCF 533 replaces the URI for the called UE with the IP address and routes the SIP invite to the called UE over ISBC 534 based on the IP address.

The called UE accepts the SIP invite to participate in a voice call with UE 501 indicates the acceptance to P-CSCF 531 over ISBC 534 via a SIP accept message. P-CSCF 531 in turn notifies S-CSCF 533 which indicates the acceptance to UE 501 over P-CSCF 531, UPFs 523, and 5G RAN 510. S-CSCF 533 directs TAS 535 to support the voice session and directs P-CSCF 531 to secure the wireless resources to carry the data for the voice session. P-CSCF 531 transfers a dedicated bearer request to secure the radio resources for the voice session over an N5 interface to one of PCFs 524. The one of PCFs 524 receives the request and directs the one of AMFs 521 to create a dedicated bearer for the voice call. The one of AMFs 521 interfaces with 5G RAN 510 to create the dedicated data radio bearer for the voice call. The one of AMFs 521 indicates that the bearer setup is complete to the one of PCFs 524 which notifies P-CSCF 531 over their N 5 interface. P-CSCF 531 informs S-CSCF 533 that bearer setup is complete.

S-CSCF 533 interfaces with the one of UPFs 523 and external systems to establish an end-to-end Realtime Transport Protocol (RTP) connection between UE 501 and the called UE to carry the voice data for the session. S-CSCF 533 transfers an indication for UE 501 that the voice session may begin to P-CSCF 531. P-CSCF 531 delivers the indication to UE 501 over the one of UPFs 523 and RAN 510. S-CSCF 533 transfers another indication for the called UE that the voice session may begin to P-CSCF 531. P-CSCF 531 delivers the indication to the called UE over ISBC 534. In response to the indication, the called UE rings its user to notify them of the requested voice call. When the user of the called UE answers the call, the called UE transfers an answer indication to P-CSCF 531 over ISBC 534. P-CSCF 531 forwards the answer indication to UE 501 over the one of UPFs 523 and RAN 510. UE 501 acknowledges the answer indication to the called UE to signify that the voice call may enter conversation mode.

The called UE generates and transfers voice data for the voice session to the one of UPFs 523 over ISBC 534. The one of UPFs 523 transfers the voice data to 5G RAN 510. 5G RAN 510 wirelessly delivers the downlink voice data to UE 501. UE 501 generates additional voice data and transfers the additional user data as uplink to RAN 510. RAN 510 transfers the additional voice data to the one of UPFs 523. The one of UPFs 523 routes the additional voice data to the called UE over ISBC 534.

NWDAF 526 is subscribed to the network and IMS functions in data centers 520 and 530 for KPI reporting. Before and during UE 501's PDU and voice sessions, AMFs 521, SMFs 522, and PCFs 524 generate and transfer network operations data that characterizes their respective UE onboarding operations performed. AMFs 521 report KPIs like registrations, PDU establishment requests, PDU session resource modifications, TAU messaging, NGAP requests, paging, and service requesting. SMFs 522 report KPIs like N1/N2 message transfer, session establishment, and session modification. PCFs 524 report KPIs like call authorization request receiving and call authorization request responding. Similarly, during the creation and serving of UE 501's PDU and voice sessions, UPFs 523, S-CSCF 533, ISBC 534, and TAS 535 generate and transfer service delivery data that characterizes their respective UE serving operations performed. UPFs 523 report KPIs like 5QI bearer drops and IMS bearer drops. P-CSCF 531, S-CSCF 533, ISBC 534, and TAS 535 reports KPIs like SIP invite/accept message delivery and call terminating. The reported network operations data and service delivery data identifies the network/IMS function type, network/IMS function ID, KPI type, KPI success rate, and KPI count.

NWDAF 526 receives the network operations data and service delivery data and groups the data by network function type, network function ID, KPI type, and success rate to generate success rate KPIs. NWDAF 526 also groups the received data by network function type, network function ID, KPI type, and count to generate count KPIs. NWDAF 526 loads the KPIs to ADRF 527.

MLF 528 initiates an anomaly detection process using its constituent machine learning models. MLF 528 retrieves the KPIs from ADRF 527. MLF 528 performs a feature extraction process on the KPIs to generate feature vectors that numerically represent the success rate and count KPIs. For the success rate feature vectors, the dimensions of the vectors represent network/IMS function type, network/IMS function ID, KPI type, and the KPI success rate. For the count feature vectors, the dimensions of the vectors represent network/IMS function type, network/IMS function ID, KPI type, and the KPI count. MLF 528 provides the success rate feature vectors to the success rate KPI machine learning model to detect anomalous success rates. MLF 528 provides the count feature vectors to the count KPI machine learning model to detect anomalous KPI counts. The models generate outputs that indicate when the success rates and/or counts for the KPIs are anomalous, identify the network/IMS functions exhibiting the anomalous behavior, and indicate when the service delivery to UE 501 is anomalous. For example, the output may indicate the PDU session resource modification KPI success rate for the one of AMFs 521 is low, the SIP message delivery KPI success rates for P-CSCF 531 and S-CSCF 533 are low, and correlate these anomalies to identify the cause of service disruption to UE 501.

When the models indicate an anomaly, MLF 528 provides the outputs to the anomaly response machine learning model to recommend responses and generate signaling to correct the anomalous behavior. The anomaly response machine learning model generates an output that comprises a software update(s) for one or more of the network functions in 5G data center 520 and/or one or more of the IMS functions in IMS data center 530 based on the outputs from the success rate and count models. MLF 528 loads the software update(s) to the anomalously behaving network/IMS functions to inhibit the anomalous behavior and restore service to UE 501. For example, the outputs from the success rate and count models may indicate one of PCFs 524 is transferring an unusually high number call authorization responses to P-CSCF 531 resulting in a signaling storm towards P-CSCF 531. The resulting signaling storm may inhibit P-CSCF 531 from effectively routing SIP messages which disrupts voice calling service for UE 501. In response, the third machine learning model may generate a software update to reduce the number of responses transferred by the one of PCFs 524 and MLF 528 may push the update towards the one of PCFs 524. Alternatively, MLF 528 may simply transfer signaling to deactivate anomalously behaving network/IMS functions based on the outputs from the machine learning models.

While MLF 528 is described as comprising a machine learning model to generate outputs to responds and autonomously correct unwanted network function behavior, in some examples MLF 528 may omit this model and instead surface the outputs from the success rate and count models to OAM 540. OAM 540 may indicate the outputs and any detected anomalies to network operators. The network operators may then generate and load an update to OAM 540 to correct the anomalous network function behavior. OAM 540 then pushes the update to network function(s) in 5G data center 520 and/or IMS function(s) in IMS data center 530.

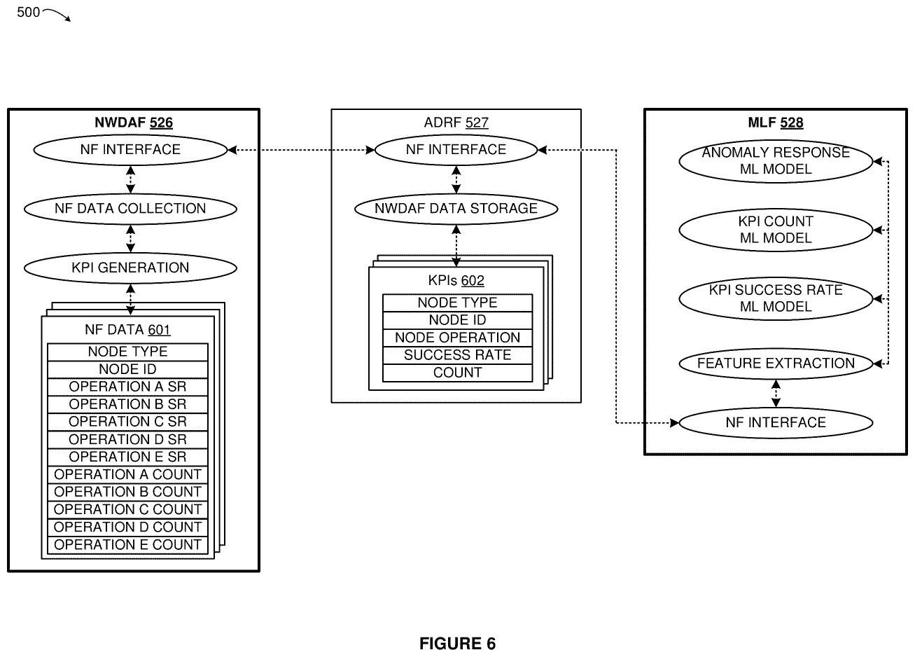

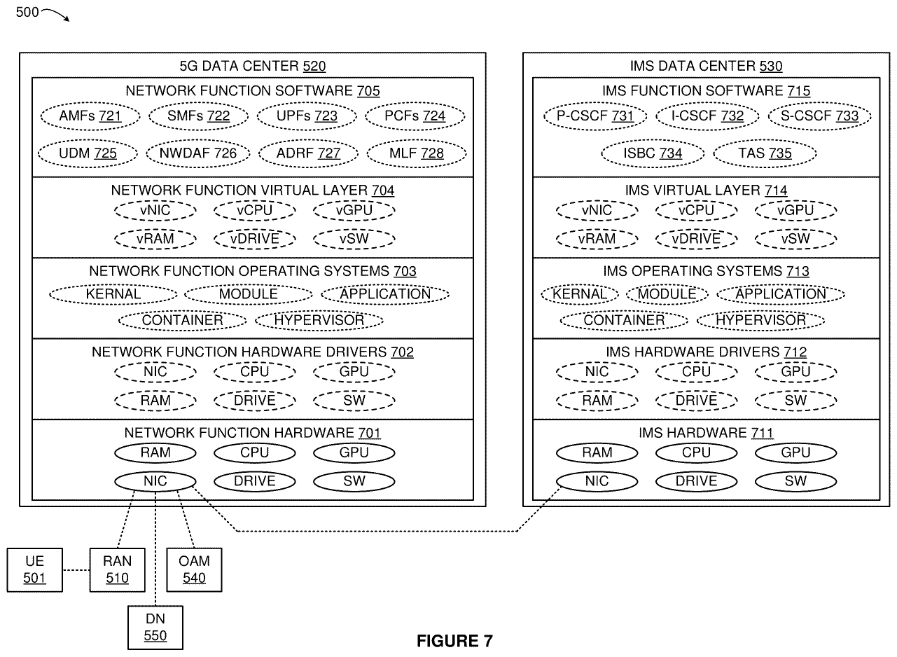

FIG. 6 illustrates NWDAF 526, ADRF 527, and MLF 528 in 5G communication network 500. In some examples, the network functions illustrated in FIG. 7 each comprise a network function (NF) interface. These interfaces allow the network functions to communication with each other and with external systems like 5G RAN 510 and IMS data center 530. For example, the network function interfaces may comprise Application Programming Interfaces (APIs). NWDAF 526 comprises modules for network function data collection and KPI generation. The network function data collection module comprises capabilities for network function and IMS function subscribing and network function data collection. As illustrated in FIG. 6, NWDAF 526 comprises network function data 601 collected by the data collection module. Network function data 601 is representative of the network operations data and service delivery data obtained from AMFs 521, SMFs 522, UPFs 523, PCFs 524, P-CSCF 531, S-CSCF 533, ISBC 534, and TAS 535. Network function data 601 comprises a node type, node ID, success rates (SR) for operations A-E, and counts for operations A-E. The KPI generation module comprises capabilities for network function data processing and KPI generation. The KPI generation module process network function data 601 to generate KPIs 602 stored by ADRF 527. Each of KPIs 602 comprises a node type, node ID, node operation, success rate, and count. ADRF 527 comprises a NWDAF data storage module and stores KPIs 602. The NWDAF data storage module comprises capabilities for data writing and data reading. The NWDAF data storage receives KPIs 602 from NWDAF 526 and writes KPIs 602 to memory. The NWDAF data storage receives requests for KPIs 602 from MLF 528 and copies KPIs 602 to MLF 528.

MLF 528 comprises a feature extraction module and machine learning (ML) models for KPI success rate, KPI count, and anomaly response. The feature extraction module comprises capabilities for feature vector generation. The feature extraction module receives KPIs 602 and generates success rate feature vectors with dimensions that represent the node type, node ID, node operation, and success rate. The feature extraction module receives KPIs 602 and generates count feature vectors that represent the node type, node ID, node operation, and count. The KPI success rate model is trained to process the success rate feature vectors to detect anomalous KPI success rates. The KPI count model is trained to process the count feature vectors to detect anomalous KPI counts. The anomaly response model is trained to process the outputs from the other models to suggest responses to detected anomalies and generate updates to inhibit the anomalous behavior.

FIG. 7 illustrates 5G data center 520 and IMS data center 530 in 5G communication network 500. 5G data center 520 comprises an example of core network 120 illustrated in FIG. 1, although core network 120 may differ. 5G data center 520 and IMS data center 530 typically use a virtualized computing architecture like NFVI, however other computing architectures may be used. 5G data center 520 comprises network function hardware 701, network function hardware drivers 702, network function operating systems 703, network function virtual layer 704, and network function software 705. Network function hardware 701 comprises Network Interface Cards (NICs), CPU, GPU, RAM, Flash/Disk Drives (DRIVE), and Data Switches (SW). Network function hardware drivers 702 comprise software that is resident in the NIC, CPU, GPU, RAM, DRIVE, and SW. Network function operating systems 703 comprise kernels, modules, applications, containers, hypervisors, and the like. Network function virtual layer 704 comprises vNIC, vCPU, vGPU, vRAM, vDRIVE, and vSW. Network function software 705 comprises AMFs 721, SMFs 722, UPFs 723, PCFs 724, UDM 725, NWDAF 726, ADRF 727, and MLF 728. Additional network function software like AUSF, UDR, NSSF, CHF, HLR, HSS, NRF, SMSF, NEF, AF, EIR, and SCP is typically present but is omitted for clarity.

IMS data center 530 comprises IMS hardware 711, IMS hardware drivers 712, IMS operating systems 713, IMS virtual layer 714, and IMS function software 715. IMS hardware 711 comprises NICs, CPU, GPU, RAM, DRIVE, and SW. IMS hardware drivers 712 comprise software that is resident in the NIC, CPU, GPU, RAM, DRIVE, and SW. IMS operating systems 713 comprise kernels, modules, applications, containers, hypervisors, and the like. IMS virtual layer 714 comprises vNIC, vCPU, vGPU, vRAM, vDRIVE, and vSW. IMS function software 715 comprises P-CSCF 731, I-CSCF 732, S-CSCF 733, ISBC 734, and TAS 735. Additional IMS function software like SMS AS, RCS AS, BGCF, and ENUM is typically present but is omitted for clarity.

5G data center 520 and IMS data center 530 may be co-located, each located at a single site, or be distributed across multiple geographic locations. The NIC in network function hardware 701 is coupled to 5G RAN 510, OAM 540, data network 550, the NIC in IMS hardware 711, and to external systems (not illustrated). The NIC in IMS hardware 711 is coupled to the NIC in network function hardware 701 and to external systems (not illustrated). Network function hardware 701 executes network function hardware drivers 702, network function operating systems 703, network function virtual layer 704, and network function software 705 to form AMFs 521, SMFs 522, UPFs 523, PCFs 524, UDM 525, NWDAF 526, ADRF 527, and MLF 528. IMS hardware 711 executes IMS hardware drivers 712, IMS operating systems 713, IMS virtual layer 714, and IMS function software 715 to form P-CSCF 531, I-CSCF 532, S-CSCF 533, ISBC 734, and TAS 735.

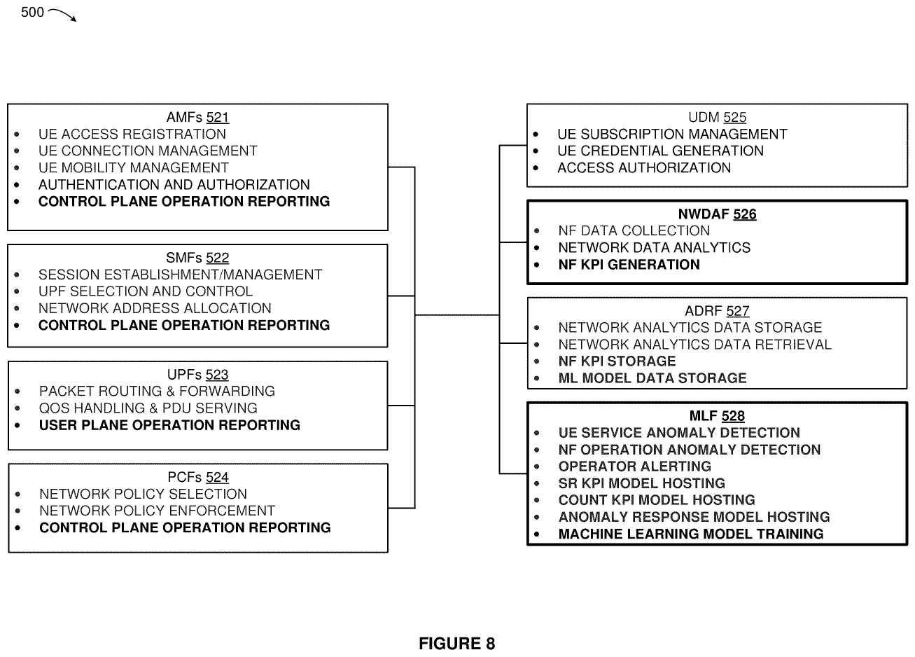

FIG. 8 further illustrates 5G data center 520 in 5G communication network 500. AMFs 521 comprise capabilities for UE registration, UE connection management, UE mobility management, authentication, authorization, and control plane operation reporting. SMFs 522 comprise capabilities for session establishment, session management, UPF selection, UPF control, network address allocation, and control plane operation reporting. UPFs 523 comprise capabilities for packet routing, packet forwarding, QoS handling, PDU serving, and user plane operation reporting. PCFs 524 comprise capabilities for network policy selection, network policy enforcement, and control plane operation reporting. UDM 525 comprises capabilities for UE subscription management, UE credential generation, and access authorization. NWDAF 526 comprises capabilities for network function data collection, network data analytics, and network function KPI generation. ADRF 527 comprises capabilities for network analytics data storage, network analytics data retrieval, network function KPI storage, and machine learning model data storage. MLF 528 comprises capabilities for UE service anomaly detection, network function operation anomaly detection, operator alerting, success rate KPI model hosting, count KPI model hosting, anomaly response model hosting, and machine learning model training.

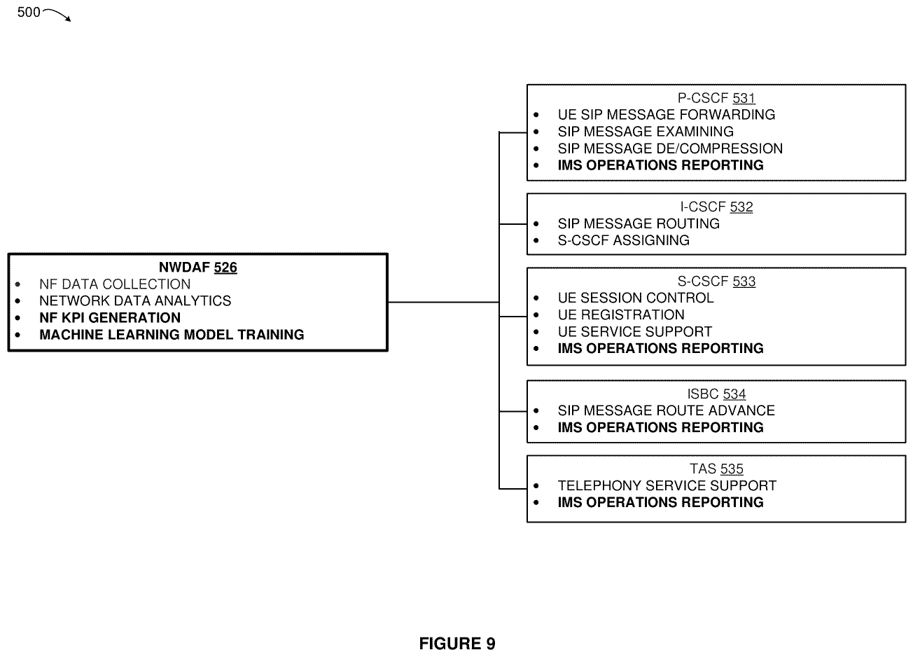

FIG. 9 further illustrates IMS data center 530 and NWDAF 526 in 5G communication network 500. P-CSCF 531 comprises capabilities for UE SIP message forwarding, SIP message examining, SIP message compression and decompression, and IMS operations reporting. I-CSCF 532 comprises capabilities for SIP message routing and S-CSCF assigning. S-CSCF 533 comprises capabilities for UE session control, UE registration, UE service support, and IMS operations reporting. ISBC 534 comprises capabilities for SIP message route advance and IMS operations reporting. TAS 535 comprises capabilities for telephony service support and IMS operations reporting.

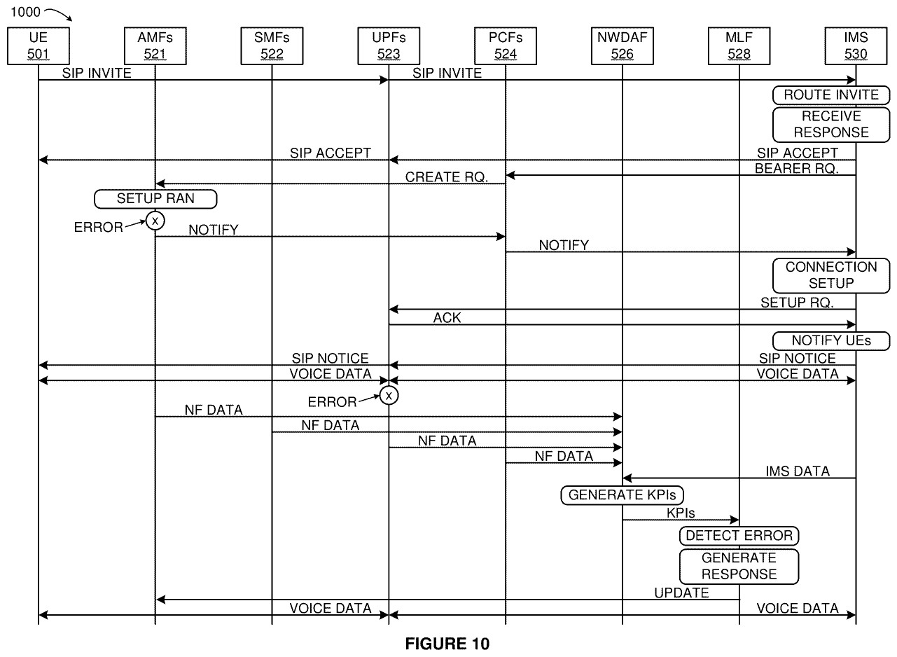

FIG. 10 illustrates process 1000. Process 1000 comprises an exemplary operation of 5G communication network 500 to utilize machine learning to detect service anomalies. Process 1000 comprises an example of processes 200 and 300 illustrated in FIGS. 2 and 3, however processes 200 and 300 may differ. Process 1000 may vary in other examples. In some examples, UE 501 receives a user input initiating a voice call with a called UE. UE 501 generates and transfers a SIP invite to P-CSCF 531 in IMS data center 530 over 5G RAN 510 and one of UPFs 523. P-CSCF 531 receives the SIP invite and forwards the invite to S-CSCF 533. S-CSCF 533 routes the SIP invite to the called UE over ISBC 534 based on the IP address. S-CSCF 533 receives a SIP accept message from the called UE over ISBC 534. S-CSCF 533 routes the SIP acceptance message to UE 501 over P-CSCF 531, the one of UPFs 523, and 5G RAN 510. S-CSCF 533 directs TAS 535 to support the voice call and directs P-CSCF 531 to request voice bearers for the call.

P-CSCF 531 transfers a dedicated bearer request to one of PCFs 524. The one of PCFs 524 forwards the request to one of AMFs 521. The one of AMFs 521 interfaces with 5G RAN 510 to create the dedicated data radio bearer for the voice call. However, an error occurs on the one of AMFs 521 and the one of AMFs 521 secures inadequate radio resources for the voice call. The one of AMFs 521 indicates that the bearer setup is complete to P-CSCF 531 over the one of PCFs 524. P-CSCF 531 informs S-CSCF 533 that bearer setup is complete. S-CSCF 533 interfaces with external systems to establish an end-to-end connection between IMS data center 530 and the called UE. S-CSCF 533 directs one of UPFs 523, typically via one of SMFs 522, to set up an end-to-end connection between UE 501 and IMS data center 530. The one of UPFs 523 establishes a tunnel to support the call and transfers an acknowledgement to S-CSCF 533 to confirm the creation. S-CSCF 533 notifies the called UE over ISBC 534 that the call may begin. S-CSCF 533 transfers a SIP notice to UE 501 over P-CSCF 531, the one of UPFs 523, and 5G RAN 510. UE 501 exchanges voice data for the call with the one of UPFs 523. The one of UPFs 523 exchanges voice data with ISBC 534. ISBC 534 exchanges the voice data with the called UE over external systems. During the voice call, an error occurs on the one UPFs 523 limiting the bit rate of the voice call due to the anomalous operation of the one of AMFs 521 (i.e., allocating insufficient radio resources for the call).

NWDAF 526 is subscribed to AMFs 521, SMFs 522, UPFs 523, PCFs 524, P-CSCF 531, S-CSCF 532, ISBC 534, and TAS 535 for data reporting. AMFs 521, SMFs 522, and PCFs 524 generate and transfer network operations data that characterizes their respective UE call setup operations. UPFs 523, S-CSCF 533, ISBC 534, and TAS 535 generate and transfer service delivery data that characterizes their respective UE call serving operations. The data reported by the one of AMFs 521 indicates the inadequate radio resource assignment. The data reported by the one of UPFs 523 indicates the limited bit rate for the call. NWDAF 526 receives the network operations data and service delivery data and groups the data by network function type, network function ID, operation type, and operation success rate to generate success rate KPIs. NWDAF 526 also groups the received data by network function type, network function ID, KPI type, and operation count to generate count KPIs. NWDAF 526 provides the KPIs to MLF 528 via ADRF 527.

MLF 528 initiates an anomaly detection process using its constituent machine learning models. MLF 528 retrieves the KPIs from ADRF 527. MLF 528 performs a feature extraction process on the KPIs to generate feature vectors that numerically represent the success rate and count KPIs. MLF 528 provides the success rate feature vectors to the success rate KPI machine learning model. MLF 528 provides the count feature vectors to the count KPI machine learning model. The models generate outputs that indicate the one of AMFs 521 did not successfully interface with 5G RAN 510 to assign adequate radio resources for the voice call and indicate the bit rate supported by the one of UPFs 523 is low. MLF 528 provides the outputs from the success rate and count models to its anomaly response machine learning model. The anomaly response module generates an output that recommends increasing the amount of radio resources for the call and that includes corrective signaling to drive the one of AMFs 521 to assign adequate radio resource for this and future voice calls. MLF 528 pushes an update that includes the corrective signaling to the one of AMFs 521. The one of AMFs 521 receives and processes the update. In response, the one of AMFs 521 interfaces with 5G RAN 510 to allocate more radio resources for the voice call. UE 501 exchanges additional voice data for the call with the one of UPFs 523 at an improved bit rate due to the increase in radio resources. The one of UPFs 523 exchanges additional voice data with ISBC 534 which in exchanges the additional voice data with the called UE over external systems. While the above operation is described with respect to anomaly detection in a VoNR call, it should be appreciated that the above operation may be used to detect anomalies in other call types like VoLTE.

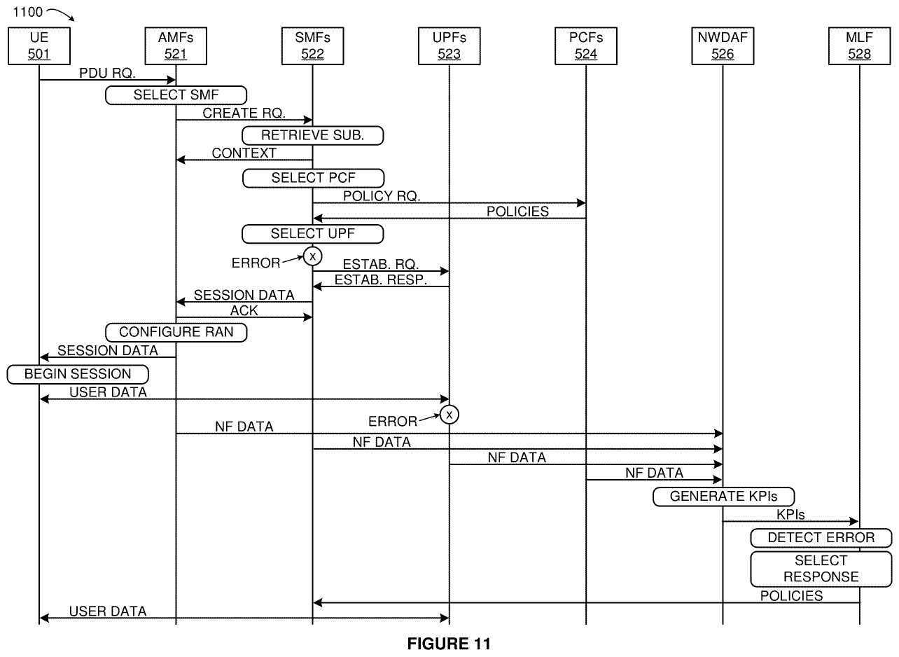

FIG. 11 illustrates process 1100. Process 1100 comprises an exemplary operation of 5G communication network 500 to utilize machine learning to detect service anomalies. Process 1100 comprises an example of processes 200, 300, and 1000 illustrated in FIGS. 2, 3, and 10, however processes 200, 300, and 1000 may differ. Process 1100 may vary in other examples. In some examples, 5G UE 501 transfers a PDU session request to one of AMFs 521 over 5G RAN 510. The one of AMFs 521 selects an SMF for the PDU session. The one of AMFs 521 transfers a create session request to one of SMFs 522. The one of SMFs 522 interfaces with UDM 525 to retrieve subscriber data and generate session context. The one of SMFs 522 provides the session context to AMFs 521. The one of SMFs 522 selects one of PCFs 524 and requests network policies for the PDU session. The one of PCFs 524 provides network policies that govern the PDU session like QoS, bit rate, latency, throughput, and the like to the one of SMFs 522.

The one of SMFs 522 selects one of UPFs 523 to support the session. However, an error occurs on the one of SMFs 522 causing it to select a UPF that lacks the capabilities to enforce the network policies selected by the one of PCFs 524. The one of SMFs 522 transfers a session establishment request to the selected one of UPFs 523. The one of UPFs 523 creates a tunnel to support the session and transfers a session establishment response to the one of SMFs 522 to confirm tunnel creation. The one of SMFs 522 transfers session data and indicates to the one of AMFs 521 that the PDU session is ready to begin. The session data includes network addresses, the selected network policies, and/or other data for UE 501 to begin the session. The one of AMFs 521 configures 5G RAN 510 based on the session data and forwards the session data to UE 501. UE 501 begins the session and exchanges user data with the one of UPFs 523 over 5G RAN 510. The one of UPFs 523 exchanges the user data with data network 450. During the PDU session, an error occurs on the one UPFs 523 inhibiting the one of UPFs 523 from providing the required QoS for the session due to the anomalous operation of the one of SMFs 522 (i.e., improper UPF selection).

NWDAF 526 is subscribed to AMFs 521, SMFs 522, UPFs 523, and PCFs 524 for data reporting. AMFs 521, SMFs 522, and PCFs 524 generate and transfer network operations data that characterizes their respective UE session setup operations. UPFs 523 generate and transfer service delivery data that characterizes their respective UE serving operations. The data reported by the one of SMFs 522 indicates the improper UPF selection. The data reported by the one of UPFs 523 indicates the failure to meet the required QoS. NWDAF 526 receives the network operations data and service delivery data and groups the data by network function type, network function ID, operation type, and success rate to generate success rate KPIs. NWDAF 526 also groups the received data by network function type, network function ID, KPI type, and count to generate count KPIs. NWDAF 526 provides the KPIs to MLF 528 via ADRF 527.

MLF 528 initiates an anomaly detection process using its constituent machine learning models. MLF 528 retrieves the KPIs from ADRF 527. MLF 528 performs a feature extraction process on the KPIs to generate feature vectors that numerically represent the success rate and count KPIs. MLF 528 provides the success rate feature vectors to the success rate KPI machine learning model. MLF 528 provides the count feature vectors to the count KPI machine learning model. The models generate outputs that indicate the one of SMFs 522 did not successfully select a UPF with capabilities to support the QoS of the PDU session and the one of UPFs 523 is not meeting the QoS requirements of the session. MLF 528 provides the outputs from the success rate and count models to its anomaly response machine learning model. The anomaly response module generates an output that recommends reselecting the UPF and that includes corrective signaling to drive the one of SMFs 522 to correct its UPF selection process. MLF 528 pushes an update that includes the corrective signaling to the one of SMFs 522. The one of SMFs 522 receives and processes the update. In response, the one of SMFs 522 reselects a UPF with capabilities to support the QoS of the PDU session. UE 501 exchanges additional user data for the PDU session with the newly selected one of UPFs 523 at the PDU session's required QoS. The one of UPFs 523 exchanges the additional user data with data network 450.

The wireless data network circuitry described above comprises computer hardware and software that form special-purpose network circuitry to utilize machine learning to detect service anomalies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to utilize machine learning to detect service anomalies.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
obtaining, by a network analytics system, network performance data associated with one or more device setup operations and service delivery data associated with one or more session setup operations from network entities in a communication network;
generating, by the network analytics system, feature vectors that include dimensions that represent the network performance data and the service delivery data;
ingesting, by a machine learning engine, the feature vectors, wherein the machine learning engine is trained to correlate one or more anomalous device setup operations with one or more anomalous session setup operations;
generating, by the machine learning engine, a machine learning output that indicates at least one anomalous session setup operation, at least one anomalous device setup operation that correlates to the at least one anomalous session setup operation, and that identifies one or more of the network entities associated with the at least one anomalous operation based at least on the feature vectors; and
surfacing, by the machine learning engine, an alert to network operators based on the machine learning output.

2. The method of claim 1 wherein:
obtaining, by the network analytics system, the network performance data comprises obtaining, by the network analytics system, network entity types, network entity Identifiers (IDs), and device setup operations data from the network entities and combining the network entity types, the network entity IDs, and the device setup operations data to form device setup Key Performance Indicators (KPIs); and
generating, by the network analytics system, the feature vectors that include the dimensions that represent the network performance data comprises generating, by the network analytics system, device setup feature vectors that represent the device setup KPIs and that include the dimensions that represent the network entity types, the network entity IDs, and the device setup operations data.

3. The method of claim 2 wherein:
the device setup operations data comprises device setup operation types, success rates for the device setup operation types, and counts for the device setup operation types; and
the device setup feature vectors further include the dimensions that represent the network entity types, the network entity IDs, the device setup operation types, the success rates for the device setup operation types, and the counts for the device setup operation types.

4. The method of claim 1 wherein:
obtaining, by the network analytics system, the service delivery data comprises obtaining, by the network analytics system, network entity types, network entity Identifiers (IDs), and session setup operations data from the network entities and combining the network entity types, the network entity IDs, and the session setup operations data to form session setup Key Performance Indicators (KPIs); and
generating, by the network analytics system, the feature vectors that include the dimensions that represent the service delivery data comprises generating, by the network analytics system, session setup feature vectors that represent the session setup KPIs and that include the dimensions that represent the network entity types, the network entity IDs, and the session setup operations data.

5. The method of claim 4 wherein:
the session setup operations data comprises session setup operation types, success rates for the session setup operation types, and counts for the session setup operation types; and
the session setup feature vectors further include the dimensions that represent the network entity types, the network entity IDs, the session setup operation types, the success rates for the session setup operation types, and the counts for the session setup operation types.

6. The method of claim 1 wherein the one or more session setup operations comprise one or more of multimedia call setup, Session Initiation Protocol (SIP) message reception, SIP message delivery and Protocol Data Unit (PDU) session setup.

7. The method of claim 1 wherein the one or more device setup operations comprise one or more of device registration, session establishment, and session authorization.

8. The method of claim 1 wherein the network entities comprise one or more of an Access and Mobility Management Function (AMF), Session Management Function (SMF), User Plane Function (UPF), Policy Control Function (PCF), Call Session Control Function (CSCF), Telephony Application Server (TAS), and Interconnect Session Border Controller (ISBC).

9. The method of claim 1 further comprising:
obtaining, by the network analytics system, historical network performance data associated with one or more historical device setup operations and historical service delivery data associated with one or more historical session setup operations from the network entities;
generating, by the network analytics system, training feature vectors that include historical dimensions that represent the historical network performance data and the historical service delivery data;
ingesting, by the machine learning engine, the training feature vectors and generating, by the machine learning engine, a training machine learning output that predicts at least one anomalous historical session setup operation, at least one anomalous historical device setup operation that correlates to the at least one anomalous historical session setup operation, and one or more of the network entities associated with the at least one anomalous historical operation based at least on the training feature vectors;
comparing, by the machine learning engine, the training machine learning output to the historical network performance data and the historical service delivery data to determine a training state of the machine learning engine; and
adjusting, by the machine learning engine, its constituent machine learning algorithms based on the training state.

10. A system comprising:
a network analytics system configured to:
obtain network performance data associated with one or more device setup operations and service delivery data associated with one or more session setup operations from network entities in a communication network; and
generate feature vectors that include dimensions that represent the network performance data and the service delivery data; and
a machine learning engine configured to:
ingest the feature vectors, wherein the machine learning engine is trained to correlate one or more anomalous device setup operations with one or more anomalous session setup operations;
generate a machine learning output that indicates at least one anomalous session setup operation, at least one anomalous device setup operation that correlates to the at least one anomalous session setup operation, and that identifies one or more of the network entities associated with the at least one anomalous operation based at least on the feature vectors; and
surface an alert to network operators based on the machine learning output.

11. The system of claim 10 wherein the network analytics system is further configured to:
obtain network entity types, network entity Identifiers (IDs), and device setup operations data from the network entities and combine the network entity types, the network entity IDs, and the device setup operations data to form device setup Key Performance Indicators (KPIs); and
generate device setup feature vectors that represent the device setup KPIs and that include the dimensions that represent the network entity types, the network entity IDs, and the device setup operations data.

12. The system of claim 11 wherein:
the device setup operations data comprises device setup operation types, success rates for the device setup operation types, and counts for the device setup operation types; and
the device setup feature vectors further include the dimensions that represent the network entity types, the network entity IDs, the device setup operation types, the success rates for the device setup operation types, and the counts for the device setup operation types.

13. The system of claim 10 wherein the network analytics system is further configured to:
obtain network entity types, network entity Identifiers (IDs), and session setup operations data from the network entities and combining the network entity types, the network entity IDs, and the session setup operations data to form session setup Key Performance Indicators (KPIs); and
generate session setup feature vectors that represent the session setup KPIs and that include the dimensions that represent the network entity types, the network entity IDs, and the session setup operations data.

14. The system of claim 13 wherein:
the session setup operations data comprises session setup operation types, success rates for the session setup operation types, and counts for the session setup operation types; and
the session setup feature vectors further include the dimensions that represent the network entity types, the network entity IDs, the session setup operation types, the success rates for the session setup operation types, and the counts for the session setup operation types.

15. The system of claim 10 wherein the one or more session setup operations comprise one or more of multimedia call setup, Session Initiation Protocol (SIP) message reception, SIP message delivery, and Protocol Data Unit (PDU) session setup.

16. The system of claim 10 wherein the one or more device setup operations comprise one or more of device registration, session establishment, and session authorization.

17. The system of claim 10 wherein the network entities comprise one or more of an Access and Mobility Management Function (AMF), Session Management Function (SMF), User Plane Function (UPF), Policy Control Function (PCF), Call Session Control Function (CSCF), Telephony Application Server (TAS), and Interconnect Session Border Controller (ISBC).

18. One or more non-transitory computer readable storage media having program instructions stored thereon, wherein the program instruction, when executed by a computing system, direct the computing system to perform operations, the operations comprising:
obtaining network performance data associated with one or more device setup operations and service delivery data associated with one or more session setup operations from network entities in a communication network;
generating feature vectors that include dimensions that represent the network performance data and the service delivery data;
utilizing a machine learning engine trained to correlate one or more anomalous device setup operations with one or more anomalous session setup operations to ingest the feature vectors and generate a machine learning output that indicates at least one anomalous session setup operation, at least one anomalous device setup operation that correlates to the at least one anomalous session setup operation, and that identifies one or more of the network entities associated with the at least one anomalous operation based at least one the feature vectors; and
surfacing an alert to network operators based on the machine learning output.

19. The computer readable storage media of claim 18 wherein the one or more session setup operations comprise one or more of multimedia call setup, Session Initiation Protocol (SIP) message reception, SIP message delivery, and Protocol Data Unit (PDU) session setup.

20. The computer readable storage media of claim 18 wherein the one or more device setup operations comprise one or more of device registration, session establishment, and session authorization.
